(19) United States
(12) Patent Application Publication
(10) Pub. No.: US 2007/0140673 A1
(43) Pub. Date: Jun. 21, 2007

(54) Multifunction dual lens matching device for stereoscopic 3D camera system

(76) Inventors: Bernard J. Butler-Smith, Malibu Lake, CA (US); Steven J. Schklair, Altadena, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/486,369

(22) Filed: Jul. 14, 2006

Related U.S. Application Data
(60) Provisional application No. 60/698,964, filed on Jul. 14, 2005.

(51) Int. Cl. G03B 17/00

(52) U.S. Cl. 396/49

(57) ABSTRACT

This invention is for target remapping, telecentricity compensation, and a new PID motion control algorithm to align and control to a very high tolerance multiple functions to two lenses simultaneously in a stereoscopic 3D camera system. To control two lenses in a 3D camera rig such that they match as closely as possible in “actual” positions, a new error variable is calculated, based on the difference between the “actual” positions of both lenses. This is added to the PID formula, as a new statement, with a new coefficient, which we call the PID3D algorithm.

### CROSS-REFERENCE TO RELATED APPLICATIONS

This application claims priority to provisional application entitled, MULTIFUNCTION DUAL LENS MATCHING DEVICE FOR A STEREOSCOPIC 3D DIGITAL CAMERA SYSTEM, filed Jul. 14, 2005, having a Ser. No. 60/698,964, which is hereby incorporated by reference in its entirety.

### FIELD OF THE INVENTION

The present invention relates generally to stereoscopic 3D camera systems, and more particularly to the lenses used by such cameras.

### BACKGROUND OF THE INVENTION

Most implementations of motion control for a camera's lens system use a dedicated motion control chip (such as a National Semiconductor LM629). These chips behave as a co-processor in a multi-axis motion control system. They typically implement the common PID (Proportional, Integral, Derivative) algorithm for motion control, along with trajectory generation, velocity profiling, quadrature position feedback, and PWM circuits.

While this works just fine in a regular 2D camera system to control the lens positions, namely Focus, Iris, and Zoom (and sometimes Back-Focus), this does not work acceptably in a 3D camera system.

A typical stereoscopic 3D camera system consists of two cameras and two lenses. It is very important for good 3D stereography for the lenses to match in all aspects.

While the PID algorithm attempts to keep each motor moving along an ideal velocity profile (FIG. 1) containing acceleration, plateau velocity, and deceleration, based on an error value derived from the difference between the “actual” position and the “target” position of the motor. This is pretty accurate, and quite acceptable to control a 2D camera's lens system.

In a 3D camera system it is more important for the lens pairs (e.g. Focus-Left-Eye to Focus-Right-Eye) to track each other, than to individually track an ideal velocity profile. The reason is a variation in torque between both lenses will cause a mismatch for that lens pair. This is especially noticeable on a beam-splitter type 3D camera rig, where one lens is in the vertical orientation, while the other lens is in the horizontal orientation.

For this reason, this invention was implemented to remedy this problem.

### SUMMARY OF THE INVENTION

In a typical PID motion control system the PID coefficients (Proportional gain, Derivative gain, and Integral gain) are loaded depending on the mechanical constants of the motors, thereafter only positional data is needed to be loaded and refreshed as often as needed, to move the motor to the desired “target” position, using a pre-defined velocity profile (FIG. 1). The PID algorithm itself, which is a single multi-statement formula, uses the error signal (“target” position minus “actual” position) as the only independent input variable.

The symbol is normally denoted “E”.

To control two lenses in a 3D camera rig such that they match as closely as possible in “actual” position, a new error variable is calculated, based on the difference between the “actual” positions of both lenses. This is added to the PID formula, as a new statement, with a new coefficient, which we call the PID3D algorithm.

### BRIEF DESCRIPTION OF THE DRAWINGS

FIG. 1 shows a typical velocity profile for motor control, showing acceleration, plateau, and deceleration, on a velocity vs. time graph.

FIG. 2 shows typical Input-Output remapping curves, on and Input vs. Output graph.

FIG. 3a shows the narrow field of view of a camera with a long focal length lens setting, showing the optical center, and the video center.

FIG. 3b shows the wide field of view of a camera with a short focal length lens setting, showing the optical center, and the video center.

FIG. 4 shows a graph of a typical focal length as the input on the X axis, and the telecentricity offset as the output on the Y axis.

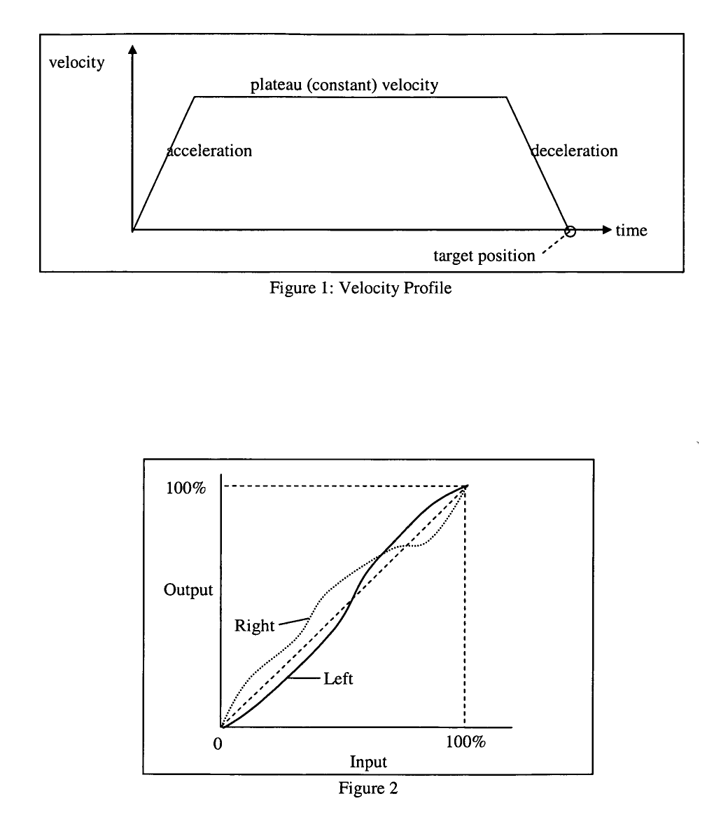

### DETAILED DESCRIPTION

The PID3D Algorithm_will drive a pair of motors to match each other, using the difference error and a new difference gain coefficient, such that the difference will generate a force to each motor to drive the motors towards each other. The difference gain coefficient needs to be sufficiently large to overcome the torque differences between both motors. The PID3D algorithm can not be implemented in a motion control co-processor, such as the National LM629 chip, commonly used by the entertainment industry for motion control. The PID processing is an internal function of these chips, and is not accessible by the outside world. We started from scratch and coded our own high performance processor to perform the PID3D algorithm which runs at 75 MIPS (million instructions per second), which includes the PID3D algorithm, trajectory generation, velocity profiling, quadrature position feedback, quadrature noise filtering, target remapping (described below), ultrasonic PWM drive, serial control, and Meta-Data generation.

For further enhancement, the “target” position for each lens is remapped by an input-output curve function, with the control input (e.g. from a hand controller) generating a new calculated “target” position for each lens. This was done because the “witness marks” on the lenses are not always accurate, and because the rotational end-stop for each lens barrel (Focus, Iris, Zoom) is not always the same even if the lens is the same model from the same manufacturer. FIG. 2 shows the input-output remapping for a pair (Left & Right) lens functions.

For each input variable, two outputs are generated, and these are the new target positions for the “left” and “right” motors of a lens function pair.

These curves would be stored for each lens used in the 3D rig, and saved into non-volatile memory, or recording medium, which may be later recalled when a specific lens is required for use.

The curves may be generated manually, by storing adjustments made manually by fine-tuning the motors using the motion control system. For an automated system, image processing is required, and described below by each lens function.

Automated Focus Alignment by Image Processing:

The system focuses on resolution charts placed at pre-defined distances from the camera/s. For each chart, the automated system would use the motion control to sweep the focus throughout its range to find the best focus for the distance of the chart. This uses image processing to find the best focus. The image-processing algorithm for this function includes edge detection and a high-pass-filer to narrow in on the highest frequency detail of the chart.

Automated Iris Alignment by Image Processing:

The system requires the 3D rig to be mechanically and optically “nulled” such that both cameras see an identical image. The cameras are pointed at a chart with sufficient contrast, such as a gray-level staircase chart. The automated system would use the motion control to sweep both irises throughout their range to find the best match between both cameras. The image-processing algorithm for this function includes image subtraction and/or image correlation, to narrow in on the best match for each gray level intensity of the chart.

Automated Zoom Alignment by Image Processing:

The system requires the 3D rig to be mechanically and optically “nulled” such that both cameras see an identical image. The cameras are pointed at a chart, such as a “Siemens Star”. The automated system would use the motion control to sweep both zooms throughout their range to find the best match between both cameras. The image-processing algorithm for this function includes image subtraction and/or image correlation, to narrow in on the best match for the sizes of the “Siemens Star” at pre-defined focal lengths.

The above automation process would store the results of the curves generated by this calibration sequence. These curves would then be used for an actual shoot using these lenses.

Telecentricity Compensation

A zoom lens for a camera has typically many moving optical elements, and it becomes difficult to maintain an optical-axis center that does not move throughout the zoom range. This invention provides a means to eliminate this movement by using motors, so that the lens will maintain true telecentricity, or optical axis matching.

For stereoscopic 3D film making, it is important that both lenses in the camera system match each other optically, so this invention provides a means for telecentric matching.

Although this invention is intended to protect our intellectual property for ongoing research in 3D stereography, it may equally be used for regular 2D cameras, to maintain zoom lens telecentricity.

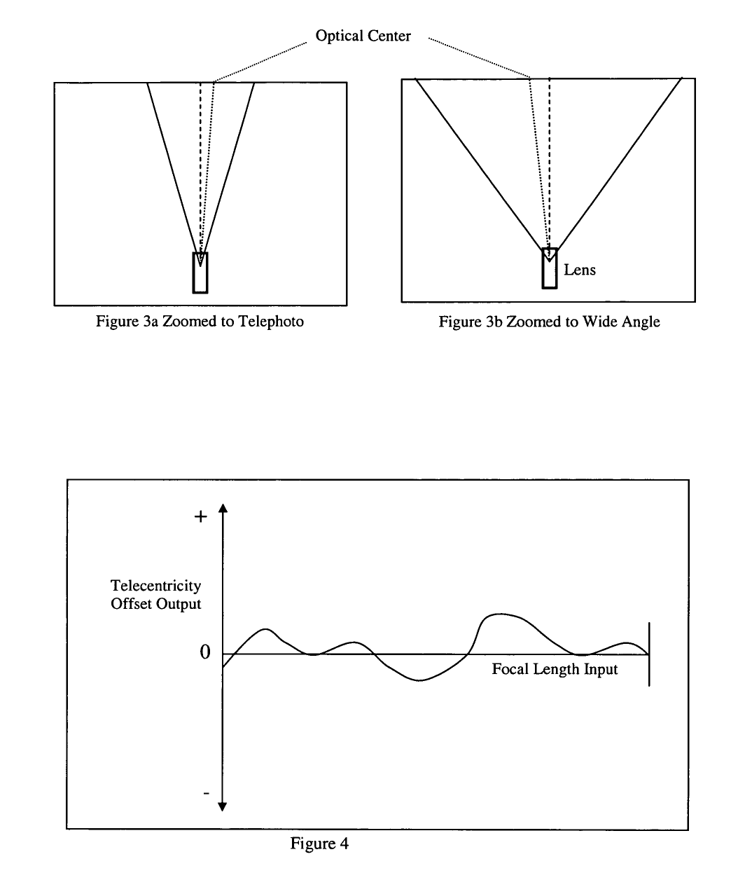

FIG. 3a and FIG. 3b show the horizontal fields of view of a zoom lens at “telephoto” focal length and “wide-angle” focal length. Notice the optical center does not match the camera (field of view) center, and that the optical center has shifted for both field of views.

This invention provides a means of forcing the optical center to track the camera's field of view center, by means of rotating the lens in the direction of the offset such that the optical center does not move throughout the zoom range. The center of rotation needs to be at the first nodal point of the lens to avoid distortion.

For a stereoscopic 3D camera rig, consisting of two cameras and lenses, ideally both lenses will require optical centers to match, so both lenses will need to be compensated so that they track each other, and the optical centers are superimposed throughout the zoom range.

The lenses are rotated using a motion-control system, and for each lens, requires a horizontal and vertical displacement, so the telecentricity matches horizontally and vertically. In the case of a typical stereoscopic 3D camera rig, where the lenses are already rotated for convergence control, the same motors can be used for horizontal telecentricity compensation, by applying an offset control to the convergence control.

A feedback signal is required from the lens, to indicate its zoom position (focal length). This signal, which can be generated by metadata from the zoom motion-control system, will be used to determine the telecentricity compensation required for each focal length.

The telecentricity compensation value for each focal length (and for each lens of a 3D system) may be generated in various ways:

1) A look-up-table (LUT) with sufficient resolution and depth to provide a smooth transition between stored telecentricity offsets.

2) A mathematical curve, in cubic-spline format with sufficiently represented points, so as to increase the statistical correlation. The plot on the Cartesian plain would be represented by the Focal Length of the lens on one axis, and the telecentricity offset on the other axis.

3) A mathematical curve, in polynomial format with sufficient order, so as to create a smooth curve. The plot on the Cartesian plain would be represented by the Focal Length of the lens on one axis, and the telecentricity offset on the other axis.

The calculated value from the curve (FIG. 4), or LUT, is sent directly to the motion control system, for the lens to be moved in the compensation direction to the new “target” position, based on the present Focal Length of the zoom.

In the case of a 3D rig with existing convergence motion control, the calculated value from the curve, or LUT, is added or subtracted from the convergence control value (or values if there are 2 convergence motors), upon which the convergence motion control system will generate new horizontal compensation directions to the new “target” positions, for the present Focal Length of the zoom.

Convergence motor Targets:

Target Left=Convergence Left+ Telecentricity Compensation Left
Target Right=Convergence Right+ Telecentricity Compensation Right

What is claimed is:

1. A process of matching two lenses in a stereoscopic 3D application.

2. A method of claim 1 using motion control electronics.

3. A method of claim 1 using an enhanced PID algorithm.

4. A method of claim 1 to match the lens functions using image processing.

5. A method of claim 1 to match the focus of both lenses.

6. A method of claim 1 to match the iris of both lenses.

7. A method of claim 1 to match the zoom of both lenses.

8. A process of matching the optical centers of both lenses in a stereoscopic application.

9. A method of claim 8 using motion control electronics.

10. A method of claim 8 using a look-up-table (LUT).

11. A method of claim 8 using a mathematical curve.

12. A method of claim 8 by adding the calculated offset to the motion control of the convergence motor/s.
